(19) United States
(12) Patent Application Publication
(10) Pub. No.: US 2013/0140269 A1
(43) Pub. Date: Jun. 6, 2013

(54) METHOD AND MECHANISM OF PHOTORESIST LAYER STRUCTURE USED IN MANUFACTURING NANO SCALE PATTERNS

(71) Applicants: Donyau Chiang, Hsinchu (TW); Chun-Ming Chang, Hsinchu (TW); Yu-Hsin Lin, Hsinchu (TW); Chin-Tien Yang, New Taipei City (TW); Chung-Ta Cheng, Taipei City (TW)

(72) Inventors: Donyau Chiang, Hsinchu (TW); Chun-Ming Chang, Hsinchu (TW); Yu-Hsin Lin, Hsinchu (TW); Chin-Tien Yang, New Taipei City (TW); Chung-Ta Cheng, Taipei City (TW)

(73) Assignee: National Applied Research Laboratories

(21) Appl. No.: 13/413,229

(22) Filed: Mar. 6, 2012

(30) Foreign Application Priority Data
Dec. 5, 2011 (TW) 100144562

(51) Int. Cl. B29C 59/14; C23F 1/00; B82Y 40/00

(52) U.S. Cl. 216/12; 156/345.11; 977/887

(57) ABSTRACT

A method and a mechanism for nano scale patterns with high aspect ratios etched on both photoresist layers and a carrier substrate and uses two complementary photoresist layers as an etch mask and the laser direct-write lithography technology to quickly fabricate large-size & nano scale patterns features (1) inorganic photoresist as material of a first layer of photoresist for nano scale patterns defined by laser beam direct-write lithography and (2) polymeric organic photoresist as material of a second layer of photoresist to thicken an etch mask because of effect of oxygen plasma, which has a higher etching rate on a polymeric organic photoresist layer but a lower one on an inorganic photoresist layer. For various materials of carrier substrates applied to the present invention, there are several types of Inductively Coupled Plasma-Reactive Ion Etching technologies available for nano scale patterns continuously transferred to a carrier substrate.

### BACKGROUND OF THE INVENTION

1. Field of the Invention

The present invention relates to manufacture of submicron or nano scale patterns and is one solution which features high throughput, large-size processing area, high-precision processed pattern and low cost. Because submicron or nano scale patterns can be etched on photoresist or further transferred to carrier substrates by means of the Inductively Coupled Plasma-Reactive Ion Etching (ICP-RIE) technique without the requirement of a clean room environment, the present invention is one technology critical to various industries including memory device, optoelectronic device, semiconductor or energy for large storage capacity disc, anti-reflective coating of a crystalline silicon solar cell, high light extraction efficiency of Light Emitting Diode (LED), and sub-wavelength optical device.

2. Description of the Prior Art

The equipment and technologies to manufacture submicron or nano scale patterns are always classified to critical manufacturing tools or trade secrets regarding process techniques in various industries such as optoelectronic device, semiconductor, energy, recording media, etc.

The process of lithographic recording or master pattern transfer is always a crucial step during duplication of submicron or nano scale patterns. For example, nano pits or nano grooves necessary to the optical recording media industry are developed on an organic photoresist layer to fabricate a stamper by electroforming; nano-pit arrays for recording media based on semiconductor are developed on a silicon wafer to increase recording density; submicron or nano scale patterns on one device's surface for both industries such as energy and optoelectronic device are taken as an anti-reflective layer which improves efficiency of light energy absorbed by solar cells; patterns are etched on sapphire substrates for better light extraction efficiency of Light Emitting Diode (LED).

The conventional lithographic methods for manufacturing periodical patterns are photopolymer lithography, e-beam lithography, near-field lithography, atomic force probe lithography, laser interference lithography, X-ray lithography, laser direct-write lithography, and nano imprint. As shown in FIG. 2, a photoresist layer 22 matching an etching light source is evenly coated on a substrate 21 according to the prior art.

However, the prior arts have their own limitations. For instance, the frequently used photopolymer lithography requests prefabricated masks, which must be remanufactured to match different patterns and wastes more time, and has some shortcomings such as poor flexibility in manufacturing patterns, optical diffraction interference to restrict obtaining nano scale patterns because of polymerization occurred in polymeric organic photoresist directly exposed to a light source, and etched pits or lines uneven. The evaluations for restrictions of these methods are summarized in Table 1:

TABLE 1

| Lithographic | | | | |
|---|---|---|---|---|
| Technologies | | Equipment | Analyses and Evaluations of | |
| Title | | investment price | Technologies | |
| 1. | E-Beam | High cost (Over 3 | 1. | High-vacuum environment required |
| | Lithography | million a set for | 2. | Slow processing speed; long set-up |
| | | industrial | | time |
| | | application) | 3. | Special photoresist required; |
| | | | | high-penetrability electrons affecting |
| | | | | more areas under photoresist and |
| | | | | extending overall exposed areas |
| | | | | despite a tiny focal point concentrated |
| 2. | Near-field | High cost (Over 3 | 1. | Near-field servo difficultly |
| | lithography | million a set for | | controlled; higher NA value based on |
| | | industrial | | liquid material selected for fluid |
| | | application) | | immersing processing |
| | | | 2. | Slow processing speed |
| 3. | Atomic | Low cost | 1. | Slow scanning speed |
| | force probe | | 2. | Signal distortions caused by a worn |
| | lithography | | | probe tip and tip polluted which |
| | | | | contacts photoresist |
| 4. | Laser | High cost | 1. | Limited photoresist available |
| | interference | | 2. | Generation of cyclic and repeated |
| | lithography | | | patterns only |
| | | | 3. | Very sensitive to ambient vibration |
| 5. | X-ray | High cost | 1. | Inapplicable universally due to good |
| | lithography | | | X-ray from synchrotron radiation |
| | | | | source only |
| | | | 2. | Masks required |
| 6. | Laser | High but affordable | 1. | Optical diffraction interference limit |
| | direct-write | ost | 2. | Organic material as photoresist |
| | lithography | | | |

To solve the said problems or drawbacks, one technology disclosed in U.S. Pat. No. 7,465,530 and No. 7,782,744 integrates laser direct-write lithography and phase change material as inorganic photoresist for fabrication of submicron and nano scale patterns. This technology is advantageous to a large-size processing area and high-precision patterns and characteristic of low cost and nano scale patterns quickly manufactured.

Notwithstanding the foregoing, the phase change material functioned as inorganic photoresist conducts phase change at high temperatures implying the inorganic photoresist layer's thickness being restricted to tens of nanometers due to the limited laser power and unsatisfying a demand for most optoelectronic structures required a high aspect ratio. In addition, it is difficult to transfer nano scale patterns on a phase changed material photoresist to one substrate (e.g., sapphire, quartz, silicon wafer, silicon carbide) because of materials used in U.S. Pat. Nos. 7,465,530 and 7,782,744 easily eroded by acid or alkaline etching solution and weak resistance by ICP-RIE operation under plasma atmosphere containing halogen.

It can be seen from above descriptions that the prior arts or their improvements with various drawbacks are disadvantageous to a good design and need to be replaced.

Having considered these derivative drawbacks in the prior arts of lithographic techniques for manufacture of nano scale patterns, the inventor for the present invention made all efforts to research and successfully developed a new method for a photoresist layer structure used in manufacturing nano scale patterns.

### SUMMARY OF THE INVENTION

The object of the present invention is to provide a method and a mechanism (device) of a photoresist layer structure used in fabrication of submicron or nano scale patterns and characteristic of high throughput, large-size processing area, high-precision processed patterns and low-cost for manufacture of large storage capacity discs especially.

The other object of the present invention is to provide a method and a mechanism (device) of a photoresist layer structure used in fabrication of submicron or nano scale patterns in different fields such as optoelectronic device, semiconductor, energy, recording media, etc. and flexibly adjusted to match different manufacturing method as well as inflexible or brittle carrier substrates, for instance, sapphire substrate, quartz substrate, silicon carbide substrate lithium niobate and silicon wafer.

A photoresist layer structure which is used to embody the previous objects and available in one method and/or mechanism (device) for fabrication of nano scale patterns still has a flaw in inorganic photoresist with weak resistance to acid, alkali, and etching atmosphere containing halogen plasma except oxygen plasma by ICP-RIE. Against this background, the inventor applied one layer of polymeric organic material as a thicker etch mask under inorganic photoresist and transferred patterns, which have been developed on the inorganic photoresist layer, to the polymeric organic layer by oxygen plasma for better shielding effect of an etch mask. This mechanism (device) features (1) inorganic photoresist as material of a first layer of photoresist for nano scale patterns defined (described) by laser beam direct-write lithography and (2) polymeric organic photoresist as material of a second layer of photoresist to define nano scale patterns and thicken an etch mask because of effect of oxygen plasma, which has a higher etching rate on a polymeric organic photoresist layer but a lower one on inorganic photoresist layer, and fabricate one layer of photoresist as an etch mask resisting acid, alkaline, or halogen plasma etching by ICP-RIE. For various materials of carrier substrates, there are several plasma atmosphere options of ICP-RIE methods used in transferring nano scale patterns to carrier substrates sequentially.

### BRIEF DESCRIPTION OF THE DRAWINGS

Please refer to detailed descriptions and drawings for a preferred embodiment in the present invention hereinafter.

FIG. 1 illustrates the method or procedure for the present invention of a photoresist layer structure used in manufacturing nano scale patterns; and

FIG. 2 is the schematic diagram of one structure based on the prior art.

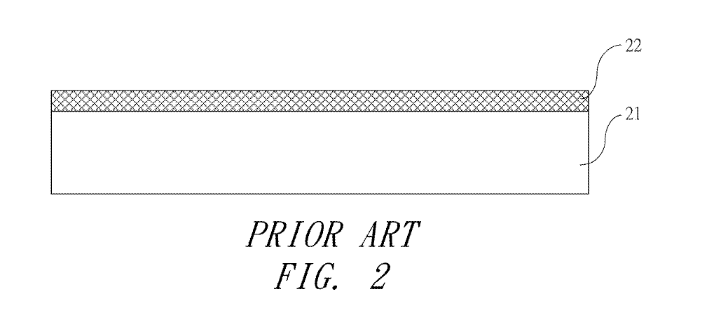

### DETAILED DESCRIPTION OF THE PREFERRED EMBODIMENT

The present invention is to fabricate predetermined submicron and nano scale patterns at a carrier substrate on which there are two layers of photoresist sequentially applied, one polymeric organic photoresist layer in the step of spin coating first and one inorganic photoresist layer in the step of sputtering deposition or vapor deposition next. The inorganic photoresist layer which is based on group 16 elements in the periodic table has some advantages such as thermal-mode laser beam direct-write, smaller burning size less than the optical diffraction interference limit, easy development in acid or alkaline solution, and strong resistance to etching atmosphere containing oxygen plasma by ICP-RIE; the organic photoresist layer comprised one of materials like PMMA, polyester or epoxy is able to resist etching atmosphere containing halogen (F or Cl) plasma.

The nano scale patterns developed on the carrier substrate are manufactured with the laser beam direct-write lithography system with one r-theta or xy table and controlled by Inductively Coupled Plasma-Reactive Ion Etching (ICP-RIE) according to material of the carrier substrate for nano scale patterns on a photoresist layer transferred to the carrier substrate (e.g., sapphire, quartz, silicon wafer, lithium niobate, silicon carbide).

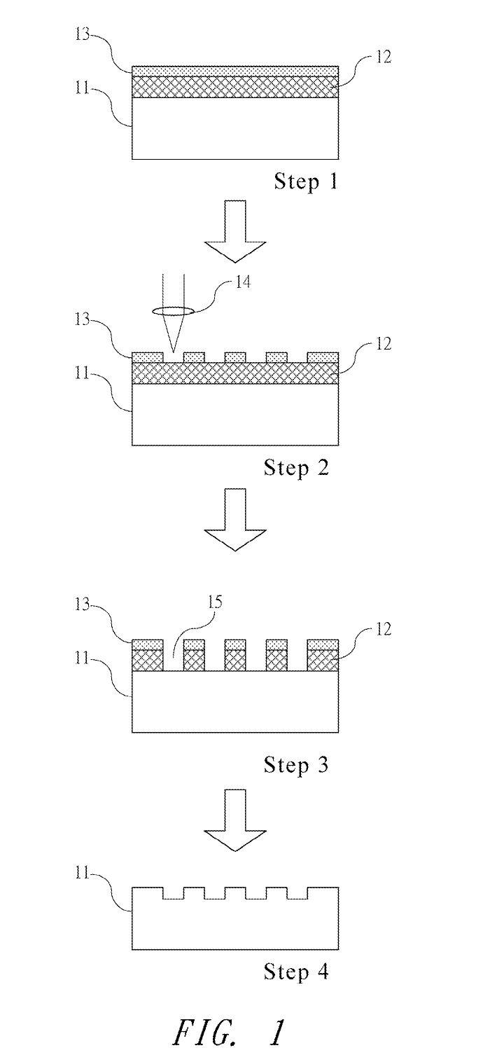

An example herein is patterns transferred to a sapphire substrate. As shown in FIG. 1, the steps for manufacture of an etched mask and the corresponding nano scale patterns on the carrier substrate are briefly introduced as follows.

Step 1: A polymeric organic photoresist layer 12 (photoresist: SU-8 2000.5) as a first layer of photoresist is coated on a carrier substrate 11 first by spin coating and an inorganic photoresist layer 13 as a second layer of photoresist is deposited on the polymeric organic photoresist layer 12 by sputtering deposition or vapor deposition to create a dual-layered etch mask without any pattern defined.

Step 2: After the dual-layered etch mask, polymeric organic photoresist layer 12 and inorganic photoresist layer 13, without any pattern defined is coated on the carrier substrate 11, a direct-write lithography technology based on laser 14 is used to define (describe) necessary nano scale patterns on the inorganic photoresist layer 13 which is to be further dipped inside etching solution for removal of any part exposed to laser 14 and complement of the inorganic photoresist layer 13 with nano scale patterns.

Step 3: As one dry etching technique, oxygen plasma 15 is used to etch the polymeric organic photoresist layer 12 (first layer of photoresist) through openings of the inorganic photoresist layer 13 (second layer of photoresist) and to define the etch mask on which there are necessary nano scale patterns with the process to expose openings completed.

Step 4: The carrier substrate 11 on which there is the etch mask with nano scale patterns at the dual-layered photoresist is further etched by a wet etching or dry etching technique to obtain nano scale structures, i.e., nano scale patterns fabricated on the carrier substrate 11 with the dual-layered photoresist.

The carrier substrate 11 used to manufacture nano scale patterns can be sapphire, glass, quartz, silicon wafer, lithium niobate, silicon carbide, thin film material, metal, plastic or other relevant flexible substrates. Similarly, both the polymeric organic photoresist layer 12 and the inorganic photoresist layer 13 are also micro-structures which can be applied to various purposes such as nano-pattern sapphire substrate, photonic crystal, anti-reflective coating, die assembly and bio-detection carrier.

It can be seen from the said descriptions that the polymeric organic photoresist layer 12 and the inorganic photoresist layer 13 as significant materials of dual-layered photoresist in the present invention are taken as an etch mask which is used to fabricate nano scale patterns on the carrier substrate 11 with the laser beam direct-write lithography technology combined.

The embodiment of the present invention featuring advantages like low production cost and high yield rate should not limit claims of the present invention. Furthermore, all changes or equivalent arrangements without departing from spirit of the present invention should be rationally covered by appended claims of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mechanism of a photoresist layer structure used in manufacturing nano scale patterns and featuring a carry-oriented substrate on which there is at least one polymeric organic photoresist layer and at least one inorganic photoresist layer sequentially coated; the inorganic photoresist layer with nano scale patterns which are directly described/defined by direct laser recording and etched by etching solution; the nano scale patterns on the polymeric organic photoresist layer which are etched by oxygen plasma and transferred from existing nano scale patterns of the inorganic photoresist layer.

2. The mechanism of a photoresist layer structure used in manufacturing nano scale patterns on the organic photoresistor layer according to claim 1 wherein the material of the inorganic photoresist layer comprises at least one element from group 16 in the periodic table.

3. The mechanism of a photoresist layer structure used in manufacturing nano scale patterns according to claim 1 wherein the organic photoresist layer comprises one of materials such as PMMA, polyester or epoxy.

4. A method of a photoresist layer structure used in manufacturing nano scale patterns, comprising: (1) one polymeric organic photoresist layer being coated by spin coating on a carrier substrate at which nano scale patterns will be manufactured; (2) one inorganic photoresist layer being deposited on the organic photoresist layer by sputtering deposition or vapor deposition; (3) nano scale patterns are defined (described) on the inorganic photoresist layer by direct laser recording and completed by chemical etching; (4) patterns being transferred to the organic photoresist layer by oxygen plasma so that the nano scale patterns exist in both the inorganic photoresist layer and the organic photoresist layer and the said patterns are finally fabricated on the carrier substrate.

5. The method of a photoresist layer structure used in manufacturing nano scale patterns according to claim 4 wherein the highly inflexible brittle carrier substrate is continuously etched by the specific plasma atmosphere of Inductively Coupled Plasma-Reactive Ion Etching (ICP-RIE) techniques depending on material of the carrier substrate so that the nano scale patterns, which have been etched on both the inorganic photoresist layer and the organic photoresist layer, are transferred to the carrier substrate.

6. The method of a photoresist layer structure used in manufacturing nano scale patterns according to claim 5 wherein the highly inflexible brittle carrier substrate can be a sapphire substrate, a quartz substrate, a silicon carbide substrate, lithium niobate or a silicon wafer.
